(19) United States
(12) Patent Application Publication
(10) Pub. No.: US 2016/0292920 A1
(43) Pub. Date: Oct. 6, 2016

(54) Time-Shift Controlled Visualization of Worksite Operations

(71) Applicant: Caterpillar Inc., Peoria, IL (US)

(72) Inventors: Christopher Sprock, East Peoria, IL (US); Ryan Baumann, Peoria, IL (US); Sanat Talmaki, Peoria, IL (US); Praveen Halepatali, Savoy, IL (US)

(73) Assignee: Caterpillar Inc., Peoria, IL (US)

(21) Appl. No.: 14/676,208

(22) Filed: Apr. 1, 2015

(51) Int. Cl. G06T 19/00; G06T 13/20; G06T 15/20; G06T 11/60

(52) U.S. Cl. CPC G06T 19/006; G06T 11/60; G06T 13/20; G06T 15/20; G06T 2215/16

(57) ABSTRACT

Systems and methods for visually reviewing worksite operations using a time-shift controlled visualization of the worksite are disclosed. One method includes receiving first data including one or more of a worksite model and information relating to operation of a worksite, where the worksite model includes a simulated operation of a machine associated with the worksite. Visualization information may be generated that represents at least a portion of the first data. A visualization may be generated based at least on the visualization information and a view of the worksite.

### TECHNICAL FIELD

This disclosure relates generally to worksite operations, and more particularly to a system and method for visualization of worksite operations.

### BACKGROUND

A worksite, such as a mining, quarry, or construction site, will typically include a variety of machines, such as bulldozers, excavators, dump trucks, and the like, working cooperatively to accomplish a particular task. In order to accomplish the task efficiently, the various machines and other elements of the worksite must be carefully coordinated and managed. As an example, a worksite may be coordinated and managed is with a computer model of the worksite. Various inputs, such as machine sensor data or global positioning system (GPS) tracking, may be used to create a model of the worksite. The model may, in turn, be used to analyze the operations of the worksite and identify areas of inefficiency. However, analysis of a model and its numerous data points may be excessively time consuming. Furthermore, it may be challenging for someone, such as a site supervisor, to relate the model to actual on-site operations.

As a further example, certain worksite activities may be presented as visualization to a user. U.S. Patent Application Publication No. 2014/0184643 discloses a system and method for coordinating machines and personnel at a worksite by providing an operator display device which displays augmenting content to an operator relating to that specific operator's activities. The disclosed system and method do not, however, provide for an augmented reality visual review of a worksite's overall operations, including a time-shifted review, such as fast-forward, pause, and rewind.

### SUMMARY

This disclosure relates to systems and methods for time-shift controlled visualization of a worksite. In an aspect, a method may include receiving, via one or more computing devices, first data comprising one or more of a worksite model and information relating to operation of a worksite, wherein the worksite model comprises a simulated operation of a machine associated with the worksite; generating, via the one or more computing devices, visualization information, based on at least a portion of the first data; receiving, via the one or more computing devices, perspective information relating to a view of the worksite; and causing a visualization to be rendered based at least on the visualization information and the positional information.

In an aspect, a system may include a processor and memory bearing instructions that, upon execution by the processor, cause the system at least to receive first data comprising one or more of a worksite model and information relating to operation of a worksite, wherein the worksite model comprises a simulated operation of a machine associated with the worksite; generate visualization information, based on at least a portion of the first data; receive perspective information relating to a view of the worksite; and cause a visualization to be rendered based at least on the visualization information and the positional information.

In an aspect, a computer readable storage medium may bear instructions that, upon execution by a processor, effectuate operations including: receiving, via one or more computing devices, first data comprising one or more of a worksite model and information relating to operation of a worksite, wherein the worksite model comprises a simulated operation of a machine associated with the worksite; generating, via the one or more computing devices, visualization information, based on at least a portion of the first data; receiving, via the one or more computing devices, perspective information relating to a view of the worksite; and causing a visualization to be rendered based at least on the visualization information and the positional information.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates an exemplary worksite in accordance with aspects of the disclosure;

FIG. 2 illustrates a schematic side view of an exemplary machine in accordance with aspects of the disclosure;

FIG. 3 illustrates a block diagram of an exemplary data flow in accordance with aspects of the disclosure;

FIG. 4 illustrates an exemplary visualization device in accordance with aspects of the disclosure;

FIG. 5 illustrates an exemplary visualization device in accordance with aspects of the disclosure;

FIG. 6 illustrates a block diagram of an exemplary data flow in accordance with aspects of the disclosure;

FIG. 7 illustrates a flow chart of an exemplary method in accordance with aspects of the disclosure; and

FIG. 8 illustrates a block diagram of a computer system configured to implement the method of FIG. 7.

### DETAILED DESCRIPTION

The systems and methods of the disclosure provide a controllable visualization of worksite operations. Such visualizations may allow a site supervisor to evaluate the operations of a worksite by viewing a visualization, such as an augmented reality view, of the worksite and time-shift controlling (e.g., fast-forwarding, pausing, or reversing) the visualization. The visualization may be generated based on information provided by machine sensor data, global navigation satellite system (GNSS) position data, or known information about the worksite or machines, as some examples. As an illustration, a site supervisor may hold a tablet computer up to a worksite, such that a camera on the tablet computer captures a view of the worksite and presents it on the display of the tablet computer. The visualization may be generated by superimposing virtual representations, such as animated machines, upon the captured view of the worksite. To the site supervisor, it will appear as if the represented machines are actually operating at the worksite. The site supervisor may control the visualization in a time-shifted manner. For example, a viewer such as the site supervisor may view animations augmented over the real-world mine site based upon the collected data. The viewer may control the animations using time shift features such as pause, fast-forward, and rewind. As another example, animations of one or more machines may be presented in augmented space and the viewer may watch the virtual animation move across the real worksite as an overlay. As the viewer changes his/her position at the worksite, the visualization models may be adjusted to provide the proper perspective of the historic machine operations to the viewer. Such overlay may be used for optimization of machine operations, visualization of inefficiencies, and/or safety evaluations. As the worksite develops, predictive modeling may be used to guide the operator in an updated plan.

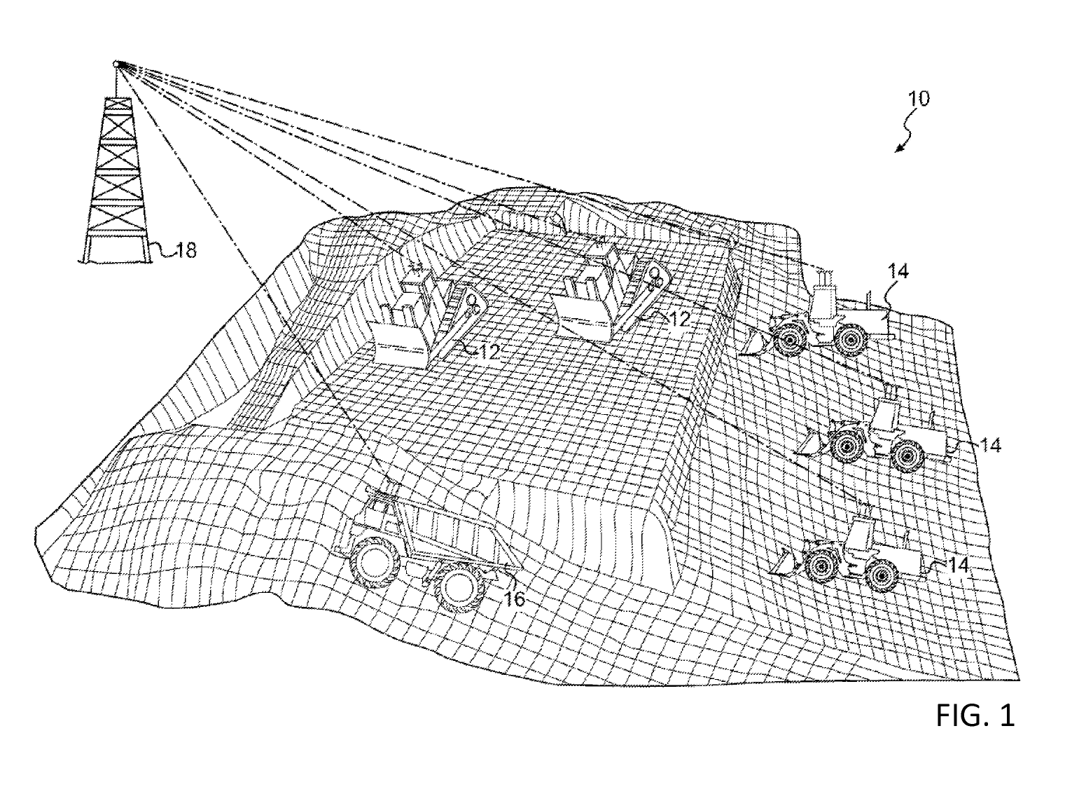

FIG. 1 shows a worksite 10 such as, for example, an open pit mining operation. It will be noted that the disclosure is not limited to open pit mining operations and is applicable to other types of worksites, such as a strip mining operation, a quarry, a construction site, an underground mining operation, and the like. As part of the mining function, various machines may operate at or between different locations of the worksite 10. These machines may include, one or more digging machines 12, one or more loading machines 14, one or more hauling machines 16, one or more transport machines (not shown), and/or other types of machines known in the art. Each of the machines at the worksite 10 may be in communication with each other and with a central station 18 by way of wireless communication to remotely transmit and receive operational data and instructions.

The digging machine 12 may refer to any machine that reduces material at the worksite 10 for the purpose of subsequent operations (e.g., for blasting, loading, and hauling operations). Examples of the digging machines 12 may include excavators, backhoes, dozers, drilling machines, trenchers, drag lines, etc. Multiple digging machines 12 may be co-located within a common area at the worksite 10 and may perform similar functions. As such, under normal conditions, similar co-located digging machines 12 should perform about the same with respect to productivity and efficiency when exposed to similar site conditions.

The loading machine 14 may refer to any machine that lifts, carries, and/or loads material that has been reduced by the digging machine 12 onto waiting hauling machines 16. Examples of the loading machine 14 may include a wheeled or tracked loader, a front shovel, an excavator, a cable shovel, a stack reclaimer, or any other similar machine. One or more loading machines 14 may operate within common areas of the worksite 10 to load reduced materials onto the hauling machines 16. Under normal conditions, similar co-located loading machines 14 should perform about the same with respect to productivity and efficiency when exposed to similar site conditions.

The hauling machine 16 may refer to any machine that carries the excavated materials between different locations within the worksite 10. Examples of the hauling machine 16 may include an articulated truck, an off-highway truck, an on-highway dump truck, a wheel tractor scraper, or any other similar machine. Laden hauling machines 16 may carry overburden from areas of excavation within the worksite 10, along haul roads to various dump sites, and return to the same or different excavation areas to be loaded again. Under normal conditions, similar co-located hauling machines 16 should perform about the same with respect to productivity and efficiency when exposed to similar site conditions.

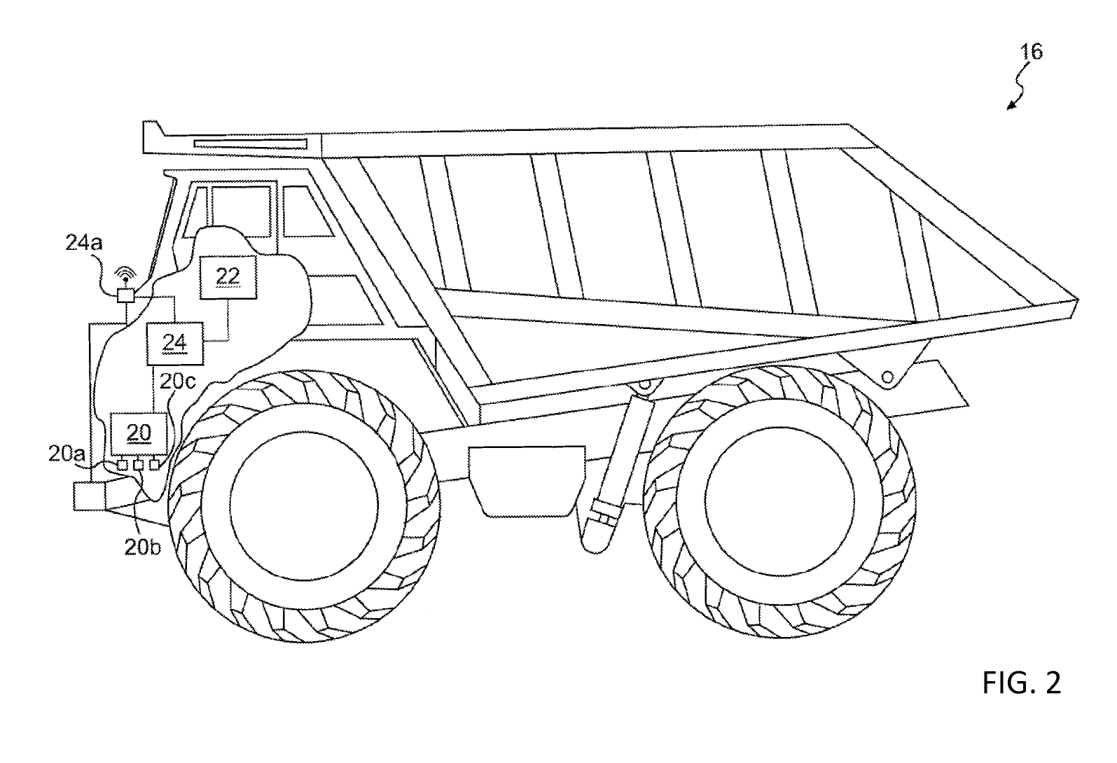

In an aspect, operations at the worksite 10 may be tracked and logged as data points. For example, positional information relating to the location, orientation, and/or movement of one or more of the machines 12, 14, 16 may be monitored and stored. Subsequently, the positional information may be used to generate visual animations representing a visualization of the positional information. Such a visualization may provide a tool to review the operations that transpired at the worksite 10 or to model future operations in a visual manner. The collection such positional information and other information is described further in reference to FIG. 2.

FIG. 2 shows one exemplary machine that may be operated at the worksite 10. It should be noted that, although the depicted machine may embody the hauling machine 16, the following description may be equally applied to any machine operating at the worksite 10. The hauling machine 16 may record and transmit data to the central station 18 (referring to FIG. 1) during its operation on a communication channel defined herein. The data may later be used to generate a computer model of the worksite 10 operations and/or a visualization, such as an augmented reality view, of the worksite 10 operations. Similarly, the central station 18 may analyze the data and transmit information to the hauling machine 16 on a communication channel defined herein. The data transmitted to the central station 18 may include operator data, machine identification data, performance data, worksite data, diagnostic data, and other data, which may be automatically monitored from onboard the hauling machine 16 and/or manually observed and input by machine operators. The information remotely transmitted back to the hauling machines 16 may include electronic terrain maps, machine configuration commands, instructions, recommendations and/or the like. In order to facilitate the generation of a computer model and/or a time-shift controlled visualization of the worksite 10, a timestamp or other indication of temporal relationship may also be recorded and associated with each segment of data.

Identification data may include machine-specific data, operator-specific data, location-specific data and/or the like. Machine-specific data may include identification data associated with a type of machine (e.g., digging, loading, hauling, etc.), a make and model of machine (e.g., Caterpillar 797 OHT), a machine manufacture date or age, a usage or maintenance/repair history, etc. Operator-specific data may include an identification of a current operator, information about the current operator (e.g., a skill or experience level, an authorization level, an amount of time logged during a current shift, a usage history, etc.), a history of past operators, operator health and biological characteristics (e.g., vital signs, nutrition levels, sleep levels, and heart rate), etc. Site-specific data may include a task currently being performed by the operator, a current location at the worksite 10, a location history, a material composition at a particular area of the worksite 10, a site-imposed speed limit, etc.

Performance data may include current and historic data associated with operation of any machine at the worksite 10. Performance data may include, for example, payload information, efficiency information, productivity information, fuel economy information, speed information, traffic information, weather information, road and/or surface condition information, maneuvering information (e.g., braking, steering, wheel slip, etc.), downtime and repair or maintenance information, etc.

Diagnostic data may include recorded parameter information associated with specific components and/or systems of the machine. For example, the diagnostic data may include engine temperatures, engine pressures, engine and/or ground speeds and acceleration, fluid characteristics (e.g., levels, contamination, viscosity, temperature, pressure, etc.), fuel consumption, engine emissions, braking conditions, transmission characteristics (e.g., shifting, torques, and speed), air and/or exhaust pressures and temperatures, engine calibrations (e.g., injection and/or ignition timings), wheel torque, rolling resistance, system voltage, etc. Some diagnostic data may be monitored directly, while other data may be derived or calculated from the monitored parameters. The diagnostic data may be used to determine performance data, if desired.

To facilitate the collection, recording, and transmitting of data from the machines at the worksite 10 to the central station 18 (referring to FIG. 1) and vice versa, each of the hauling machines 16 may include an onboard control module 20, an operator interface module 22, and a communication module 24. The communication module 24 may communicate over a communication channel as defined herein. Data received by the control module 20 and/or the operator interface module 22 may be sent offboard to the central station 18 by way of the communication module 24. The communication module 24 may also be used to send instructions and/or recommendations from the central station 18 to an operator of the hauling machine 16 by way of the operator interface module 22. It is contemplated that additional or different modules may be included onboard the hauling machine 16, if desired.

The control module 20 may include a plurality of sensors 20a, 20b, 20c distributed throughout the hauling machine 16 and configured to gather data from the various components and subsystems of the hauling machine 16. It is contemplated that a greater or lesser number of sensors may be included than that shown in FIG. 2.

The sensors 20a-c may be associated with a power source (not shown), a transmission (not shown), a traction device, a work implement, an operator station, and/or other components and subsystems of the hauling machine 16. These sensors may be configured to provide data gathered from each of the associated components and subsystems. Other pieces of information may be generated or maintained by the data control module 20 such as, for example, time of day, date, weather, road or surface conditions, and machine location (global and/or local). The sensors 20a-c and/or the control module 20 may provide an indication of a temporal relationship of the gathered data, such as providing a timestamp associated with each piece of the gathered data. A timestamp with each piece of gathered data may facilitate generation of a computer model and/or a visualization, such as an augmented reality view, of the worksite 10 operations.

The operator interface module 22 may be located onboard the hauling machine 16 for collection and/or recording of data. The operator interface module 22 may include or be communicatively connected to one or more operator data input devices such as a press-able button, a movable dial, a keyboard, a touchscreen, a touchpad, a pointing device, or any other means by which an operator may input data. As examples, an operator may use the operator interface module 22 to input observed data, such as a subjective indicator of the hauling machine's 16 mechanical condition or a perceived indicator of a road's condition. The operator interface module 22 may be communicatively connected to the central station 18, in addition to or alternatively to the connection to the control module 20.

The communication module 24 may include any device that facilitates communication of data between the hauling machine 16 and the central station 18, and/or between the machines 12, 14, 16. The communication module 24 may include hardware and/or software that enables sending and/or receiving data through a wireless communication link 24a on a communication channel as defined herein. It is contemplated that, in some situations, the data may be transferred to the central station 18 and/or other machines 12, 14, 16 through a direct data link (not shown), or downloaded from the hauling machine 16 and uploaded to the central station 18, if desired. It is also contemplated that, in some situations, the data automatically monitored by the control module 20 may be electronically transmitted, while the operator-observed data may be communicated to the central station 18 by a voice communication device, such as a two-way radio (not shown).

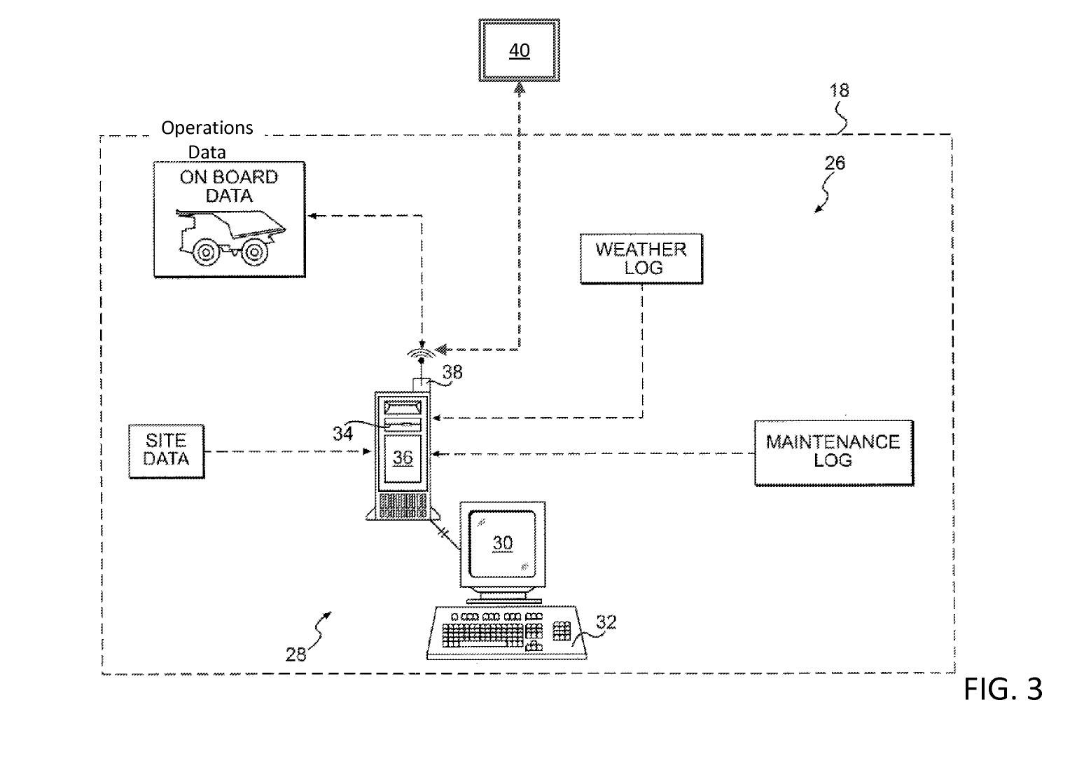

The communication module 24 may also have the ability to record the monitored and/or manually input data. For example, the communication module 24 may include a data recorder (not shown) having a recording medium (not shown). In some cases, the recording medium may be portable, and data may be transferred from the hauling machine 16 to the central station 18 or between the machines 12, 14, 16 using the portable recording medium. As such the collected data may be processed to generate visualization information to be used for providing a visual representation of the data. As an example, the visualization information may be generated locally to one or more of the machines 12, 14, 16, or at a central computing system such as the central station 18, as discussed in more detail in reference to FIG. 3.

FIG. 3 is a schematic illustration of a worksite management system 26 configured to receive and analyze the data communicated to the central station 18 from the machines 12, 14, 16 and from other sources (e.g., operators). The worksite management system 26 may include an off board controller 28 in remote communication with the machines 12, 14, 16 via the central station 18 and configured to process data from a variety of sources and execute management methods at the worksite 10. For purposes of this disclosure, the controller 28 may be primarily focused on creating a computer model of the worksite 10 and/or generating visualization information which may be used in a time-shift controlled visualization, such as an augmented reality view, to dynamically review worksite operations represented in the computer model or other data.

The controller 28 may include any type of computer or a plurality of computers networked together. The controller 28 may be located proximate the worksite 10 or may be located at a considerable distance remote from the worksite 10, such as in a different city or even a different country. It is also contemplated that computers at different locations may be networked together to form the controller 28, if desired. In one aspect, the controller 28 may be located onboard one or more of the machines 12, 14, 16 at the worksite 10, if desired.

The controller 28 may include among other things, a console 30, an input device 32, an input/output device 34, a storage media 36, and a communication interface 38. The console 30 may be any appropriate type of computer display device that provides a graphical user interface (GUI) to display results and information to operators and other users of the worksite management system 26. The input device 32 may be provided for operators to input information into the controller 28. The input device 32 may include, for example, a keyboard, a mouse, or another computer input device. The input/output device 34 may be any type of device configured to read/write information from/to a portable recording medium. The input/output device 34 may include among other things, a floppy disk, a CD, a DVD, a flash memory read/write device or the like. The input/output device 34 may be provided to transfer data into and out of the controller 28 using a portable recording medium. The storage media 36 could include any means to store data within the controller 28, such as a hard disk. The storage media 36 may be used to store a database containing among others, historical worksite, machine, and operator related data. The communication interface 38 may provide connections with the central station 18, enabling the controller 28 to be remotely accessed through computer networks, and means for data from remote sources to be transferred into and out of the controller 28. The communication interface 38 may contain network connections, data link connections, and/or antennas configured to receive wireless data.

Data may be transferred to the controller 28 electronically or manually. Electronic transfer of data may include the remote transfer of data using the wireless capabilities or the data link of the communication interface 38 by a communication channel as defined herein. Data may also be electronically transferred into the controller 28 through a portable recording medium using the input/output device 34. Manually transferring data into the controller 28 may include communicating data to a control system operator in some manner, who may then manually input the data into the controller 28 by way of, for example, the input device 32. The data transferred into the controller 28 may include data useful for creating a time-shift controlled visualization, such as an augmented reality view, and including machine identification data, performance data, diagnostic data, and other data. The other data may include for example, weather data (current, historic, and forecast), machine maintenance and repair data, site data such as survey information or soil test information, and other data known in the art.

The controller 28 may be communicatively connected, via the communication interface 38, to a visualization device 40 configured to receive and display, in a visualization, such as an augmented reality view, computer model data and/or visualization information generated by the controller 28. As described above, augmented reality occurs when the viewer's current view of the physical, real world environment is augmented with generated input that may provide further information or input about the environment being perceived. For example, the visualization device 40 may display a real-time or near real-time view of the worksite 10 received from a camera integrated with the visualization device 40. The view of the worksite 10 may be augmented with overlaid computer generated imagery or animation, such as an animation of the hauling machine 16 moving down a road of the worksite 10.

The visualization device 40 may include any manner of computing device capable of receiving computer model data of the worksite 10 and/or visualization information pertaining to the worksite 10 and then displaying a visualization of the worksite 10 based on said computer model data and/or visualization information. In general, the visualization device 40 may include a processor, memory, a communication module, and a display. The processor and memory may serve to receive the computer model data and/or visualization information, store that data, and process that data into a visualization, such as an augmented reality view. The communication module may communicate with the central station 18 and the controller 28 in order to receive the computer model data and/or visualization information. The communication module may be capable of wireless communication (e.g., on a cellular, WiFi, or satellite network) or wireline communication (e.g., on an ethernet network). The display may serve to present the visualization to the user. A display may include a light emitting diode (LED) display, a liquid crystal display (LCD), a cathode ray tube (CRT) display, or the like. The visualization device 40 may additionally include a camera to capture a view of the worksite 10 with which to create the visualization. The camera may include a charge coupled device (CCD) or the like to capture the images digitally. The visualization device 40 may further include means for user input, such as a touch-sensitive display panel (e.g., touchscreen), a pointing device (e.g., mouse, pointing stick, or touchpad), a voice-command input system, or a motion input system.

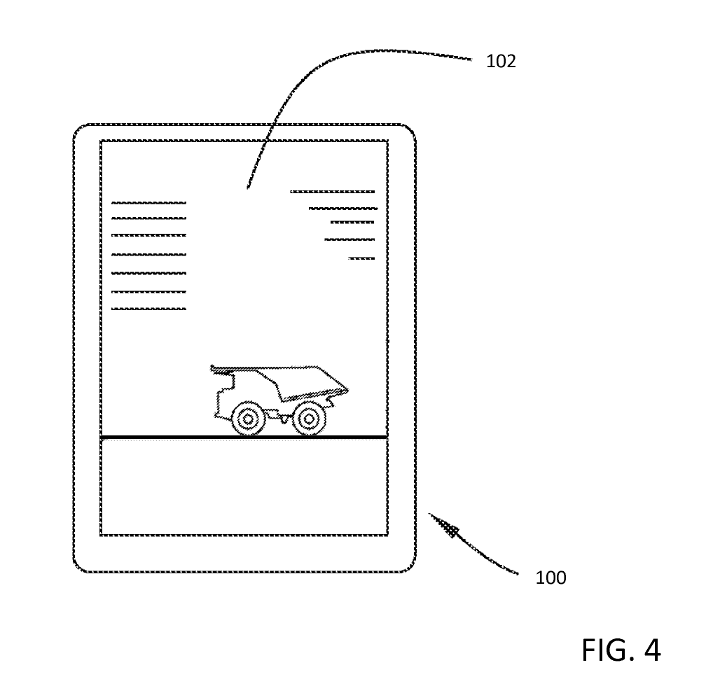

FIG. 4 depicts an exemplary visualization device 40 in the form of a tablet computer 100. The tablet computer 100 includes a display 102 upon which the user may view visualization of the worksite 10. The tablet computer 100 may include a camera (not shown) on the face of the tablet computer 100 opposite the display 102 so that the user may hold the tablet computer 100 up to a scene, such as the worksite 10, and view the scene on the display 102. The display 102 of the tablet computer 100 may be touch-sensitive and enable the user to interact with a program or application running on the tablet computer 100, including a visualization and time-shift control of the visualization.

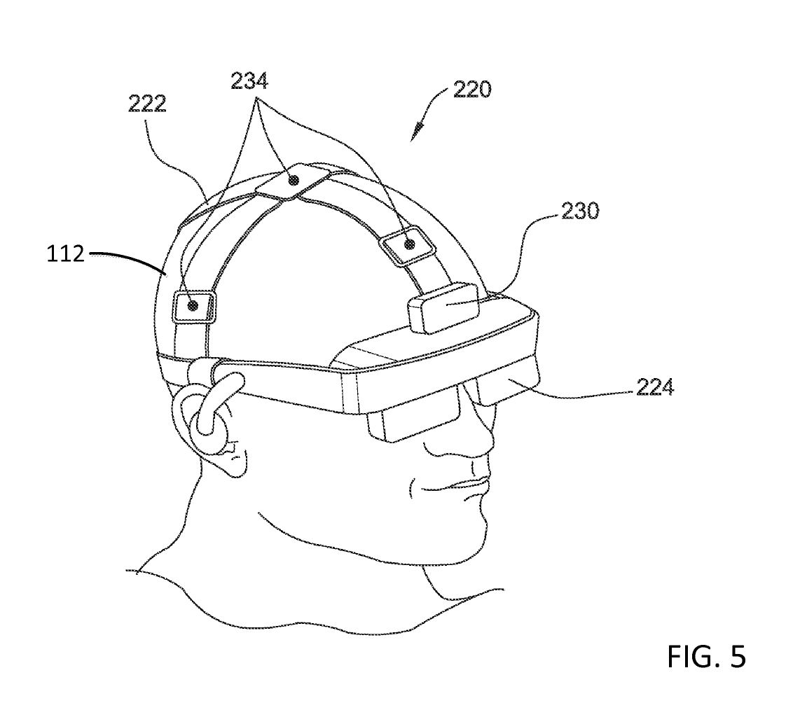

FIG. 5 depicts another exemplary visualization device 40 in the form of a head mounted display (HMD) system 220 configured for augmented reality capabilities. The HMD system 220 includes an adjustable strap or harness 222 that allows the HMD system 220 to be worn about the head of user who may be present at the worksite 10. The HMD system 220 may include a visor or goggles with transparent lenses that function as the display 224 through which the wearer views the surrounding environment. The visualization information may therefore be projected in the user's field of view as an overlay superimposed on the view of the surrounding environment. The HMD system 220 may be configured to receive visualization information not only specific to the location of the person 112, but specific to the person's line of view. For example, a plurality of sensors 234 may be disposed about the harness 222 to determine the orientation of the head of the wearer. For example, the sensors 234 may be Hall effect sensors that utilize the variable relative positions of a transducer and a magnetic field to deduce the direction, pitch, yaw and roll of an individual's head. Additionally or alternatively, the sensors 234 may be inertial sensors measuring acceleration and deceleration in one or more axes to determine position and/or orientation.

Other examples of the visualization device 40 may include a smart phone, a heads-up display (HUD) system, a laptop computer, or a personal computer. It is contemplated that the visualization device 40 may include a combination of separate components, such as a computing unit coupled with a display unit (e.g., a monitor or other digital display) and a camera. It should be appreciated that one or more components of the visualization device 40 may be in different locations, including locations other than the worksite 10. For example, a computing unit and display unit may be located off-site and a connected camera, which may be remotely controlled, may be located at the worksite 10. A visualization, such as an augmented reality view, on the display unit may present augmenting information overlaid upon the view provided by the camera at the worksite 10.

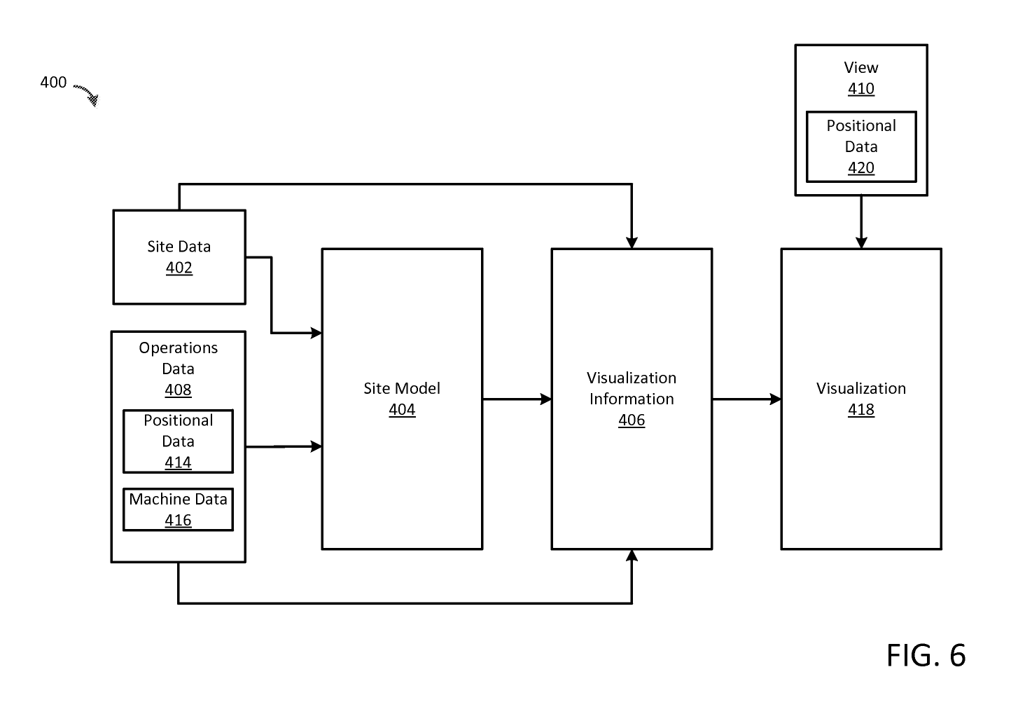

FIG. 6 depicts an exemplary flow diagram 400 of various operations relating to a method to visually review worksite operations using a time-shift controlled visualization of the worksite 10. In an aspect, a site model 404 may be accessed, received, and/or generated. The site model 404 may simulate the operations of the worksite, including one or more operations of a machine (e.g., machines 12, 14, 16 (FIG. 1)). For example, and referring back to the exemplary worksite 10 depicted in FIG. 1, the site model 404 may simulate the operation of the loading machine 14 depositing a material into the hauling machine 16. The site model 404 may, in turn, simulate the laden hauling machine 16 traveling along a road and unloading its payload to a processing machine, wherein the delivered material is simulated being processed. The site model 404 may then simulate the empty hauling machine 16 traveling back over the road to repeat the process. The site may be determined by the controller 28 or other processor. For example, the site may be determined at a server or other processor controlled by a third-party and subsequently delivered to and received by the controller 28.

The site model 404 may be based on site data 402. The site data 402 may include information on the layout and planning of the worksite 10. This may include the locations of material, a processing machine, and one or more roads. Additionally, information on the layout of the worksite 10 may include the location of a dump zone, a scale, a loadout, or the like.

The site data 402 may include performance information such as information relating to the theoretical or projected performance characteristics of the machines operating at the worksite 10. As examples, performance information may include a projected loading rate of the loading machine 14 (e.g., tons loaded per hour), a projected processing rate of a processing machine (e.g., tons processed per hour), a projected carrying capacity of the hauling machine 16 (e.g., tons of material per load), a projected maximum safe travel speed of the hauling machine 16 or the like. Performance information may also include projected performance metrics relating to the cooperative operation of more than one machine 12, 14, 16. For example, performance information may include the projected amount of time that the loading machine 14 should take to fill the bed of a particularly-sized hauling machine 16. As another example, performance information may include the projected cycle time of a complete cycle of the loading machine 14 filling the hauling machine 16, the hauling machine 16 delivering its payload to a processing machine, and the hauling machine 16 returning again to the loading machine 14.

The site data 402 may include information pertaining to the roads of the worksite 10. For example, this may include information on the material composition of a road (e.g., paved, dirt, mud or the like). Road information may also include the weight-bearing capacity of a road (e.g., 100 tons), the maximum speed at which machines 12, 14, 16 may safely operate on a road, or a metric indicating the level of deterioration of a road. The site data 402 may include a designation of a hauling route over one or more roads.

The site data 402 may include cost-related information. Cost-related information may include a purchase cost of a machine 12, 14, 16, a lease cost of a machine 12, 14, 16, an operating cost of a machine 12, 14, 16 (e.g., fuel, wear-and-tear deterioration), or the like. Other cost-related information may include wage costs for personnel associated with the worksite 10, including those personnel operating the machines 12, 14, 16. Cost-related information may additionally include road construction cost, road maintenance cost, and power costs such as for electricity or natural gas. As a further example, the site data 402 may include information pertaining to site goals. For example, site goal information may include a goal cost of operation or a goal productivity level (e.g., a particular amount of material processing in a specified period of time).

The site model 404 may additionally be based on operations data 408. The operations data 408 may include positional data 414, machine data 416, or other types of data. The operations data 408 may be transmitted to and received by the central station 18 (FIG. 3) or other computer or processor.

Positional data 414 may include any information pertaining to the location, orientation, and/or movement of machines, such as the machines 12, 14, and 16, and/or personnel at the worksite 10. Positional data 414 may include a set of geographical coordinates and a corresponding set of time intervals. The set of geographical coordinates and time intervals may collectively represent, as an example, the movement of the hauling machine 16 between a loading location and a dump location. Positional data 414 may be acquired by a variety of means, including global navigation satellite system (GNSS) tracking, machine sensor data, and video image analysis. In addition to representing current or past movement of machines and personnel, positional data 414 may represent future projected movement. For example, positional data 414 may represent a planned path for a particular machine along a series of roads of the worksite 10.

Machine data 416 may include any information pertaining to the operation of a machine 12, 14, 16. The machine data 416 may be input from the sensors 20a-c. Examples of machine data 416 gathered from the sensors 20a-c include operator manipulation of the input devices, tool, or power source, machine velocity, machine location, fluid pressure, fluid flow rate, fluid temperature, fluid contamination level, fluid viscosity, electric current level, electric voltage level, fluid (e.g., fuel, water, oil, coolant, DEF) consumption rates, payload level, payload value, percent of maximum allowable payload limit, payload history, payload distribution, transmission output ratio, cycle time, idle time, grade, recently performed maintenance, or recently performed repair.

The machine data 416 may additionally include empirical performance information, similar to that of site data 402 but instead based on actual measurements from the sensors 20a-c or other sources. For example, empirical performance information may include an actual loading rate of the loading machine 14, an actual processing rate of a processing machine, an actual carrying capacity of the hauling machine 16, or an actual maximum safe travel speed of the hauling machine 16. As with the site data 402, empirical performance information may include empirical performance metrics relating to the cooperative operation of more than one machine 12, 14, 16. As an example, empirical performance information may include the actual cycle time of the hauling machine 16 accepting a load, delivering that load, and returning for another load.

The operations data 408 may additionally include updated road information, such as real-time data on a road condition (e.g., an indication that a road is muddy, has suffered new damage, or is blocked). The operations data 408 may further include an indication of an accident involving a machine 12, 14, 16 or other safety incidents, such as a near-miss between a machine 12, 14, 15 and another object or a safety policy breach. Information pertaining to material at the worksite 10 may additionally be included in the operations data 408. For example, this may include an indication of the amount of a material, such as a pile of soil, waiting to be loaded onto the hauling machine 16. As another example, this may include an indication of the amount of deposited material at a dump site (or, conversely, the amount of material that may still be accommodated at the dump site). Information on material at the worksite 10 may include an indication of a quality of one or more materials such as a material-to-air density, moisture content, etc. The operations data 408 may include an indication of the quality of work performed at the worksite 10 and can relate to the site conditions, projected work performed vs. actual worked performed, and the like.

The operations data 408 may further include an associated indication of temporal relationship, such as a timestamp. For example, positional data 414 may represent the movement of a machine over a certain time interval, including a series of coordinates. Each coordinate may have a corresponding timestamp indicating the time at which the machine was at that coordinate. The indication of temporal relationship may facilitate the creation of the site model 404, visualization information 406, and a visualization 418. In particular, the indications of temporal relationship for an associated portion of operations data 408 may allow the visualization of the worksite 10 operations to be time-shifted (e.g., viewed in fast-forward or reverse modes).

In an aspect, visualization information 406 may be accessed, received, and/or generated. The visualization information 406 may be based on the site model 404, site data 402, operations data 408, or a combination thereof. The visualization information 406 may refer to information which represents one or more aspects of the worksite 10 operations and is usable by the visualization device 40 to generate a visualization 418 (e.g., visual feedback, overlay, augmented reality view, etc.) representing the worksite 10 operations. The accessing, receiving, and/or generation of the visualization information 406 may be performed by the controller 28 or the visualization device 40.

The visualization information 406 may include a virtual representation, such as an image or animation, of various elements of the worksite 10, such as one of the machines 12, 14, 16, personnel, roads, materials, of the like. The virtual representations may be generated, accessed, and/or retrieved based on the site model 404, site data 402, operations data 408, or a combination thereof. For example, an animation of the hauling machine 16 may be generated that shows a three dimensional image of the hauling machine 16 traveling from one point to another. This animation may be generated, for example, from a series of coordinates (e.g., GNSS coordinates) and timestamps included in the positional data 414 and machine identification included in the machine data 416, or other data included in the site model 404, site data 402, or operations data 408. It will be appreciated that a library of virtual representations may be stored in, for example, the controller 28 or visualization device 40. The library may store complete or partial virtual representations that may be modified according to the site model 404, site data 402, or operations data 408 to generate visualization information or a portion thereof. For example, the library may include a three-dimensional digital representation of the hauling machine 16, amenable to animation within an augmented or virtual space. If the site model 404, site data 402, or operations data 408 indicate the presence of the hauling machine 16 at the worksite 10 and that the hauling machine 16 moved, an animation of the hauling machine 16 moving may be generated by retrieving the three-dimensional digital representation from the library and animating the movement of the hauling machine 16 according to coordinates and timestamps in the positional data 414. It will also be noted that any reference to a virtual representation, animation, or image may refer to one or more digital files containing binary data embodying said virtual representation, animation, or image, such that the digital file may be used, by the visualization device 40 for example, to generate the visualization 418.

The virtual representation may be formatted in a manner which permits time-shifted playback of the virtual representation (e.g., it may be fast-forwarded, paused, or played in reverse). For example, an animation may include a sequential series of independent frames, such that the frames may each be viewed as a still representation of the worksite 10 operations (i.e., the visualization 418 may be paused), the frames may be viewed at an accelerated rate (i.e., the visualization 418 may be fast forwarded), or the frames may be viewed in a reverse order (i.e., the visualization 418 may be rewound or viewed in reverse, at a standard or accelerated rate). As another example, in the event that an animation or other virtual representation does not generally include independent frames (e.g., the content of one frame is dependent on a previous frame to create a cohesive animation or rendering), one or more independent frames, known as “I” or “intra” frames in the art, may be included at regular intervals in the sequence of frames forming the animation or other virtual representation (e.g., every twenty-fourth frame). An “I” or “intra” frame contains a full representation of the animation or other virtual representation for that particular frame. When an animation or other virtual representation is paused, fast-forwarded, viewed in reverse, or viewed in another non-standard viewing mode, the playback device (e.g., the visualization device 40) may playback the “I” or “intra” frames to effectuate the selected non-standard viewing mode. For example, a fast-forward viewing of an animation with “I” or “intra” frames may include the sequential presentation of only the “I” or “intra” frames. Since the “I” or “intra” frames are interspersed at regular intervals among the standard frames (e.g., every twenty fourth frame), it will appear to a viewer that the animation is being fast-forwarded.

In addition to a virtual representation of elements of the worksite, visualization information 406 may include other data useful for the visualization 418 to be generated. This data may include positional data relevant to the virtual representation derived from the positional data 414 or data describing the location of the virtual representation in relation to one or more fiducial markers of the worksite 10. Such data may allow the virtual representation to be correctly positioned relative to the view 410 of the worksite 10 in the visualization. For example, the positional data in the visualization information 406 may be correlated with perspective information such as positional data 420 relating to the worksite and/or the view 410 of the worksite, such as fiducial marker coordinates, to facilitate the proper placement of a virtual representation in the visualization 418. As a further example, one or more fiducials or other digital positional markers may represent a physical feature of a worksite such as a dumpsite. As such, the dumpsite marker represented in the visualization information 406 may be aligned with a dumpsite marker of a real-time view (e.g., via the visualization device 40) to provide proper orientation of the visualization 418 overlaying the actual view of the worksite 10. As a further example, visualization information 406 may additionally include timing information, such as indications of temporal relationship or timestamps. Timing information may allow virtual representations to be displayed in the visualization 418 at the correct time relative to other virtual representations. Timing information may also facilitate the time-shifted playback of the visualization 418.

In an aspect, the visualization information 406 may be used to generate a visual feedback such as the visualization 418. The visualization 418 may refer to a view of the worksite 10 that is simultaneously supplemented with a visual representation of the visualization information 406. The visualization 418 may be generated by combining the visual representation of the visualization information 406 based on the view 410 (e.g., perspective information, positional data 420, etc.) of the worksite 10. In some aspects, the visualization 418 may be an augmented reality view, wherein the visualization information 406, such as animations, images, or other virtual representations, is overlaid upon a direct or indirect view of the actual worksite 10. In other aspects, the visualization 418 may be a virtual reality view, wherein the visualization information 406 is combined with a virtual reality representation of the worksite 10.

In one aspect, the view 410 may be a live, real-world perspective of the worksite 10. In this aspect, the visualization 418 may be created by generating a visual feedback based on at least the visualization information 406 via a material through which the viewer may still directly perceive the viewer's real-world surroundings. For example, visualization information 406 may be rendered via the transparent lens of the head mounted display (HMD) system 220 shown in FIG. 5 or the like. As another example, a visualization 418 may be generated by displaying the visualization information 406 on the transparent material of a heads-up display (HUD), a lens of a smartglasses, or a retina in a retinal projector.

In another aspect, the view 410 may be an indirect perception of the worksite 10. For example, the view 410 may be captured by a camera connected to or incorporated within the visualization device 40. To illustrate, the tablet computer 100 depicted in FIG. 4 may include a camera opposite the display 102. The viewer may hold the tablet computer 100 up to a scene, such as the worksite 10, and the camera may capture the view 410 of the worksite 10 and display the view 410 on the display 102.

In another aspect, the view 410 may be a virtual-reality view of the worksite 10. The view 410 may be generated by processing various characteristics of the worksite 10, such as the layout of the roads, geographical features, buildings, and the like, and translating the characteristics into a virtual-reality representation of the worksite 10. The virtual-reality representation of the worksite 10 may be viewed in a digital display or a head-mounted display including one or more digital displays, for example. As an example, a viewing device such as the visualization device 40 (FIG. 3) may be configured to determine perspective information relating to a user of the viewing device. Such perspective information may include positional data 420 such as location data, orientation data, and/or movement data relating to the viewing device and/or the user. As such, the positional data 420 may be relied upon to determine a viewing perspective of the user of the viewing device. As the position of the user changes, the positional data 420 is updated and the resultant visual perspective may be updated. As a further example, the positional data 420 may be correlated with the positional data 414 to determine an appropriate perspective from which the visualization 418 should be rendered. As an illustration, when the user is oriented toward a processing plant, the overlaid visualization may represent worksite operations that would have been visible if the user were oriented toward the processing plant during a live, real-time operation. Similarly, when the user changes his/her orientation during playback, the visualization may be updated to provide a visual feedback of operations from the appropriate perspective. Although such positional data 420 is discussed in reference to a user, the positional data 420 may reference a virtual location, orientation, and/or movement to simulate a perspective of an actual on-site user.

In an aspect, the visualization 418 may be displayed on the visualization device 40. As discussed further herein, the visualization device 40 may include a tablet computer (such as the tablet computer 100 shown in FIG. 4), a head mounted display (such as the head mounted display system 220 shown in FIG. 5), a smart phone, a HUD system, a laptop computer, or a personal computer. The visualization device 40 may include a display upon which the visualization may be viewed by a user, such as a site supervisor.

The visualization 418 may be generated by combining the visualization information 406, including one or more animations, images, or other virtual representations of elements of the worksite 10, with the view 410. To illustrate, an animation included in the visualization information 406 may represent the movement of the hauling machine 16 from a loading site at the worksite 10 to a dump site at the worksite 10. This animation may be superimposed upon the view 410 of the worksite so that the viewer sees the animated hauling machine 16 moving across the real worksite 10. Of course, multiple animations, images, or other virtual representations may be incorporated into the visualization. For example, the visualization information 406 may include animations and other associated data for the digging machine 12, the loading machine 14, and the hauling machine 16 performing their respective tasks. Accordingly, the visualization 418 may include an animation of the digging machine 12 removing material from a hillside, the loading machine 14 loading the removed material onto the hauling machine 16, and the hauling machine 16 carrying the material to a dump site, all superimposed on the visualization device 40 upon the view 410.

It will be appreciated that the visualization 418 may represent the visualization information 406 that illustrates past, real- or near real-time, or future worksite 10 operations. For example, the visualization information 406 may represent worksite 10 operations from the current day at the worksite 10, wherein a site supervisor may review the operations of the worksite 10 at the end of the workday to identify inefficiencies or review a safety incident. As another example, the visualization information 406 may represent the real-time operations of the worksite 10, or as near to real-time as possible given sensing, processing, and communication delays. In this mode, a site supervisor or other analyst may check the accuracy of the site model 404 against the actual operation of the worksite 10, by comparing the superimposed animations and the like against the actual operations of the worksite 10 from the view, both displayed in the visualization. As yet another example, the visualization information 406 may represent future projected operations or characteristics of the worksite 10. To illustrate, the visualization information 406 may include representations of a contemplated alternative road layout. In the visualization, a representation of the road layout may be superimposed over the view of the worksite 10, including the actual movement and operation of machines 12, 14, 16 at the worksite 10. By viewing the actual movement and operation of the machines 12, 14, 16 in relation to the alternative road layout, a site supervisor or other viewer of the visualization may be able to see that the alternative road layout would result in traffic congestion.

In addition to a standard playback (e.g., the animation of a moving machine is displayed at the speed at which it actually occurred), animations, images, or other virtual representations included in the visualization information 406 may be time-shift controlled (sometimes known as trick play or trick mode playback). Time-shift control may refer to an ability to fast-forward, slow, pause, and/or reverse-play (at a standard, slow, or accelerated speed) content. As applied to the present disclosure, the visualization may be viewed in a fast-forward mode such that the animations, images, or other virtual representations are played at an accelerated rate. The fast-forward mode may allow a site supervisor or other viewer to review the operations of the worksite for a given time interval within a reduced period of time. In a fast-forward mode, a site supervisor may review the entire operations of the worksite 10 within, for example, thirty minutes. In a slow mode, a site supervisor may slow the playback of the visualization at a particular moment of the playback in order to focus on, for example, a particular safety incident, such as a collision between two machines. In a reverse mode, a site supervisor may be able to rewind the playback of the visualization 418 in order to review a particular period of time multiple times, such as the aforementioned collision. Additionally, the visualization may be paused. A site supervisor may pause the visualization in order to more carefully analyze the operations of the worksite 10 at a particular moment. For example, a site supervisor may pause the visualization 418 to analyze the relative position of the machines 12, 14, 16 preceding the aforementioned collision.

### INDUSTRIAL APPLICABILITY

The industrial applicability of the system and methods for visually reviewing worksite 10 operations using a time-shift controlled visualization (e.g., visualization 418) of the worksite 10 herein described will be readily appreciated from the foregoing discussion. Although various machines 12, 14, 16 are described in relation to FIG. 1, those skilled in the art may understand that the machine 12, 14, 16 is not so limited and may include any manner of work vehicle or equipment that may be found at a worksite. Similarly, although the hauling machine 16 is depicted in FIG. 2, any type of work vehicle or equipment may be used.

Conventionally, site supervisors or analysts evaluate the operations of a worksite by analyzing raw data derived from on-machine sensors, GNSS data, and the like. The raw operations data may sometimes be input into a site simulation module to derive a computer model representing the worksite operations. Projected data may also be input into a site simulation module to generate a predictive model of future worksite operations. These techniques, however, do not allow a site supervisor or analyst to view the historical or projected operations within the context of the actual worksite. By presenting the data and/or model in a visualization, such as an augmented reality view, a site supervisor or analyst may perceive virtual representations, such as an animation, of machines moving and operating superimposed upon a direct, indirect, or virtual reality view of the worksite. In addition, since the visualization may be time-shift controlled (e.g., fast forwarded, paused, reversed), the site supervisor or analyst may review the worksite operations within a reduced amount of time, pause at a critical moment, or reverse and replay a critical time frame of operations.

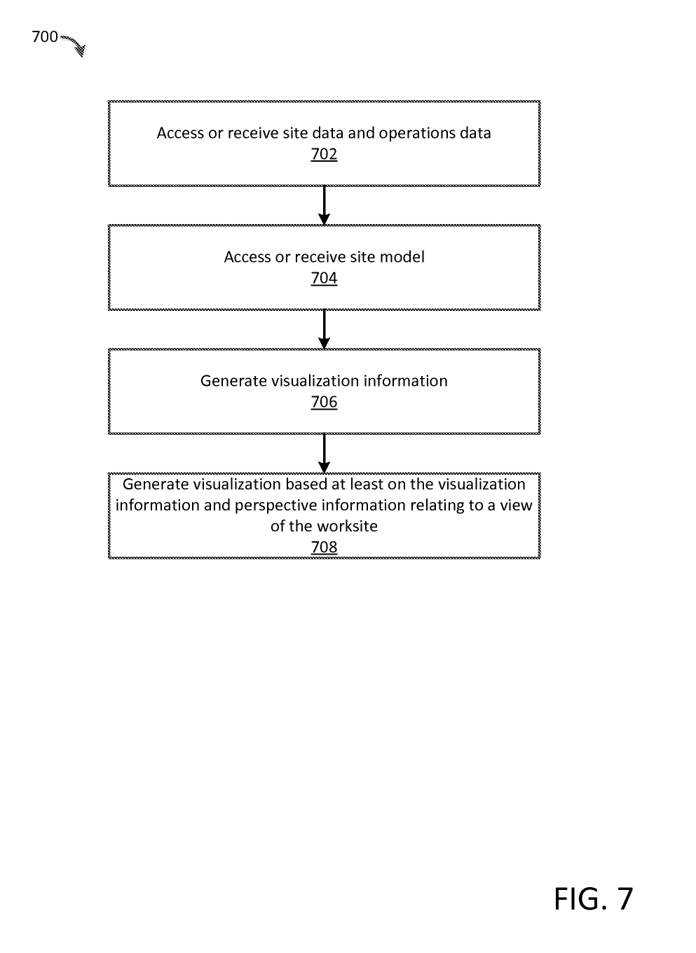

FIG. 7 illustrates a process flow chart for a method 700 for visually reviewing worksite operations using a time-shift controlled visualization of the worksite. For illustration, the operations of the method 700 will be discussed in reference to FIGS. 1, 2, 3, 4, 5, and 6. At step 702, the site data 402 and/or the operations data 408 may be accessed or received. As an example, the site data 402 and/or the operations data 408 may be received by the controller 28. The site data 402 and/or the operations data 408 may be previously stored on the controller 28 or may be received from another server or processor, including one associated with a third party. Other data may be received or accessed and may be used in processing the collective data.

At step 704, a site model (e.g., site model 404) may be accessed or received that simulates the operations of the worksite 10. The site model may be accessed or received by the controller 28, for example, after the site model is determined based, at least in part, on the site data 402 and/or the operations data 408. The determination of the site model may be performed by the controller 28 or another processor, including one controlled by a different party than that controlling the controller 28. In addition, the site model may be accessed or received by the visualization device 40 when, for example, the visualization information 406 is to be rendered via the visualization device 40.

At step 706, visualization information such as visualization information 406 may be accessed or received. The visualization information 406 may be accessed or received by the controller 28 or the visualization device 40. The visualization information 406 may be based on the site model, site data 402, operations data 408, or a combination thereof. The visualization information 406 may represent one or more aspects of the worksite 10 operations and may include a virtual representation, such as an image, animation, of one or more elements of the worksite 10, such as one of the machines 12, 14, 16, personnel, roads, materials, or the like. As an example, a virtual representation may include a three dimensional representation of the hauling machine 16 animated to show the hauling machine 16 traveling from one location of the worksite 10 to another. This animation may be generated, for example, from a series of coordinates (e.g., GNSS coordinates) and timestamps included in the positional data 414 and machine identification included in the machine data 416, or other data included in the site model, site data 402, or operations data 408. The virtual representation, and the visualization information 406 as a whole, may be formatted in a manner which permits time-shifted playback of the virtual representation in a visualization (e.g., it may be fast-forwarded, paused, or played in reverse).

The visualization information may additionally include data useful for a visualization to be generated, including positional data relevant to the virtual representation derived from the positional data 414 or data describing the location of the virtual representation in relation to one or more fiducial markers of the worksite 10. Timing information, such as an indication of a temporal relationship or a timestamp, may be included in the visualization information to facilitate the correct representation in the visualization and the time-shift control of the visualization.

At step 708, a visualization (e.g., visualization 418) may be generated by, for example, the visualization device 40. The visualization may be generated based, at least in part, on the visualization information of step 706. The visualization may be displayed on the visualization device 40, which may be held or otherwise used by a site supervisor or analyst at the worksite 10. In some aspects, the visualization may be considered an augmented reality view of the worksite 10.

The visualization may be generated by combining the visualization information with perspective information relating to a viewpoint of the worksite 10. For example, a virtual representation represented by the visualization information, such as an animation or image of the machine 12, 14, 16, may be superimposed upon a real-world or virtual view of the worksite 10 so that, to the viewer, it appears as if the animated machine 12, 14, 16 is actually operating at the worksite 10. The viewpoint of the worksite 10 may include a live, real-world view of the worksite 10, such as through a transparent material (e.g., a window or a lens) upon which a virtual representation may be projected or otherwise displayed. The viewpoint may include an indirect perception of the worksite 10. For example, the view of the worksite may be captured by a camera and then displayed on a digital display. As an illustration, the camera and the digital display may both be incorporated into a single visualization device 40, such as the tablet computer 100 shown in FIG. 4. The view may further include a virtual-reality view of the worksite 10, wherein the various characteristics and elements of the worksite 10 are translated into a virtual reality representation of the worksite 10.

As an example, the visualization information may include animations and other associated data for the digging machine 12, the loading machine 14, and the hauling machine 16 performing their respective tasks. Accordingly, the visualization may display an animation of the digging machine 12 removing material from a hillside, the loading machine 14 loading the removed material onto the hauling machine 16, and the hauling machine 16 carrying the material to a dump site, all superimposed on the visualization device 40 upon the view 410.

In one aspect, the visualization may represent past operations of the worksite 10 and, accordingly, may be used to review and evaluate the past operations. For example, a site supervisor may view the visualization at the end of the work day to evaluate the performance of the worksite 10 for that day. As another example, if an accident had occurred at the worksite 10, a site supervisor may view the visualization for the time interval during and just preceding the accident in order to gain an understanding of the circumstances of the accident and determine a root cause. In another aspect, the visualization may represent current operations of the worksite 10. In yet another aspect, the visualization may represent projected operations of the worksite 10 and may be used to evaluate a predictive model.

In an aspect, the visualization may be time-shift controlled, which refers to an ability to fast-forward, slow, pause, and/or reverse-play (at a standard, slow, or accelerated speed) the visualization. For example, the visualization may be viewed in a fast-forward mode such that the animations, images, or other virtual representations are played at an accelerated rate. The fast-forward mode may allow a site supervisor or other viewer to review the operations of the worksite for a given time interval within a reduced period of time. In a slow mode, a site supervisor may slow the playback of the visualization at a particular moment of the playback in order to focus on, for example, a particular safety incident, such as a collision between two machines. In a reverse mode, a site supervisor may be able to rewind the playback of the visualization in order to review a particular period of time multiple times, such as the aforementioned collision. Additionally, the visualization may be paused. A site supervisor may pause the visualization in order to more carefully analyze the operations of the worksite 10 at a particular moment. For example, a site supervisor may pause the visualization to analyze the relative position of the machines preceding the aforementioned collision.

Whether such functionality is implemented as hardware or software depends upon the design constraints imposed on the overall system. Skilled persons may implement the described functionality in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., control module 20, controller 28, visualization device 40, etc.) that implements a portion or all of one or more of the technologies described herein may include a general-purpose computer system that includes or is configured to access one or more computer-accessible media.

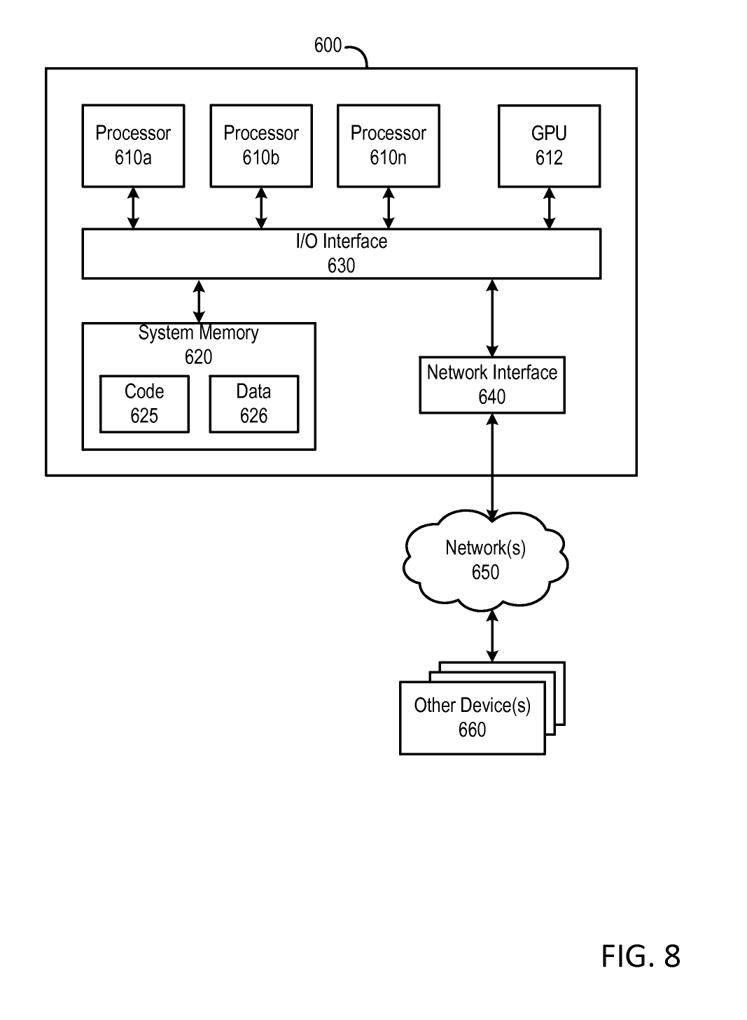

FIG. 8 depicts a general-purpose computer system that includes or is configured to access one or more computer-accessible media. In the illustrated aspect, a computing device 600 may include one or more processors 610a, 610b, and/or 610n (which may be referred herein singularly as the processor 610 or in the plural as the processors 610) coupled to a system memory 620 via an input/output (I/O) interface 630. The computing device 600 may further include a network interface 640 coupled to an I/O interface 630.

In various aspects, the computing device 600 may be a uniprocessor system including one processor 610 or a multiprocessor system including several processors 610 (e.g., two, four, eight, or another suitable number). The processors 610 may be any suitable processors capable of executing instructions. For example, in various aspects, the processor(s) 610 may be general-purpose or embedded processors implementing any of a variety of instruction set architectures (ISAs), such as the x86, PowerPC, SPARC, or MIPS ISAs, or any other suitable ISA. In multiprocessor systems, each of the processors 610 may commonly, but not necessarily, implement the same ISA.

In some aspects, a graphics processing unit (“GPU”) 612 may participate in providing graphics rendering and/or physics processing capabilities. A GPU may, for example, include a highly parallelized processor architecture specialized for graphical computations. In some aspects, the processors 610 and the GPU 612 may be implemented as one or more of the same type of device.

The system memory 620 may be configured to store instructions and data accessible by the processor(s) 610. In various aspects, the system memory 620 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within the system memory 620 as code 625 and data 626.

In one aspect, the I/O interface 630 may be configured to coordinate I/O traffic between the processor(s) 610, the system memory 620 and any peripherals in the device, including a network interface 640 or other peripheral interfaces. In some aspects, the I/O interface 630 may perform any necessary protocol, timing or other data transformations to convert data signals from one component (e.g., the system memory 620) into a format suitable for use by another component (e.g., the processor 610). In some aspects, the I/O interface 630 may include support for devices attached through various types of peripheral buses, such as a variant of the Peripheral Component Interconnect (PCI) bus standard or the Universal Serial Bus (USB) standard, for example. In some aspects, the function of the I/O interface 630 may be split into two or more separate components, such as a north bridge and a south bridge, for example. Also, in some aspects some or all of the functionality of the I/O interface 630, such as an interface to the system memory 620, may be incorporated directly into the processor 610.

The network interface 640 may be configured to allow data to be exchanged between the computing device 600 and other device or devices 660 attached to a network or networks 650, such as other computer systems or devices, for example. In various aspects, the network interface 640 may support communication via any suitable wired or wireless general data networks, such as types of Ethernet networks, for example. Additionally, the network interface 640 may support communication via telecommunications/telephony networks, such as analog voice networks or digital fiber communications networks, via storage area networks, such as Fibre Channel SANs (storage area networks), or via any other suitable type of network and/or protocol.

In some aspects, the system memory 620 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 600 via the I/O interface 630. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 600 as the system memory 620 or another type of memory. Further, a computer-accessible medium may include transmission media or signals, such as electrical, electromagnetic or digital signals, conveyed via a communication medium, such as a network and/or a wireless link, such as those that may be implemented via the network interface 640. Portions or all of multiple computing devices, such as those illustrated in FIG. 8, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

According to an example, the global navigation satellite system (GNSS) may include a device and/or system that may estimate its location based, at least in part, on signals received from space vehicles (SVs). In particular, such a device and/or system may obtain “pseudorange” measurements including approximations of distances between associated SVs and a navigation satellite receiver. In a particular example, such a pseudorange may be determined at a receiver that is capable of processing signals from one or more SVs as part of a Satellite Positioning System (SPS). Such an SPS may comprise, for example, a Global Positioning System (GPS), Galileo, Glonass, to name a few, or any SPS developed in the future. To determine its location, a satellite navigation receiver may obtain pseudorange measurements to three or more satellites as well as their positions at time of transmitting. Knowing the SV orbital parameters, these positions can be calculated for any point in time. A pseudorange measurement may then be determined based, at least in part, on the time a signal travels from an SV to the receiver, multiplied by the speed of light. While techniques described herein may be provided as implementations of location determination in GPS and/or Galileo types of SPS as specific illustrations according to particular examples, it should be understood that these techniques may also apply to other types of SPS, and that claimed subject matter is not limited in this respect.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

1. A method comprising:
receiving, via one or more computing devices, first data comprising one or more of a worksite model and information relating to operation of a worksite, wherein the worksite model comprises a simulated operation of a machine associated with the worksite;
generating, via the one or more computing devices, visualization information, based on at least a portion of the first data;
receiving, via the one or more computing devices, perspective information relating to a view of the worksite; and
causing a visualization to be rendered based at least on the visualization information and the perspective information.

2. The method of claim 1, wherein the visualization is controlled using one or more of fast-forward, pause, and rewind.

3. The method of claim 1, wherein the visualization is rendered as a visual overlay on a real-life, direct view of the worksite rendered via at least a semi-transparent material disposed between a user's eye and the actual worksite.

4. The method of claim 1, wherein the perspective information comprises a location and orientation of a user.

5. The method of claim 1, wherein the visualization information comprises first positional data and the perspective information comprises second positional data, and wherein causing the visualization to be rendered is further based on a correlation between first positional data and second positional data.

6. The method of claim 5, wherein the first positional data is associated with global navigation satellite system (GNSS) data.

7. The method of claim 1, wherein the visualization comprises an animation of the machine associated with the worksite.

8. A system comprising:
a processor; and
a memory bearing instructions that, upon execution by the processor, cause the system at least to:
receive first data comprising one or more of a worksite model and information relating to operation of a worksite, wherein the worksite model comprises a simulated operation of a machine associated with the worksite;
generate visualization information, based on at least a portion of the first data;
receive perspective information relating to a view of the worksite; and
cause a visualization to be rendered based at least on the visualization information and the perspective information.

9. The system of claim 8, wherein the visualization may be controlled using one or more of fast-forward, pause, and rewind.

10. The system of claim 8, wherein the visualization is rendered as a visual overlay on a real-life, direct view of the worksite rendered via at least a semi-transparent material disposed between a user's eye and the actual worksite.

11. The system of claim 8, wherein the visualization comprises a digital and indirect view of the worksite rendered via a digital display.

12. The system of claim 8, wherein the perspective information comprises a location and orientation of a user.

13. The system of claim 8, wherein the visualization information comprises first positional data and the perspective information comprises second positional data, and wherein causing the visualization to be rendered is further based on a correlation between first positional data and second positional data.

14. The system of claim 13, wherein the first positional data is associated with global navigation satellite system (GNSS) data.

15. A computer readable storage medium bearing instructions that, upon execution by a processor, effectuate operations comprising:
receiving, via one or more computing devices, first data comprising one or more of a worksite model and information relating to operation of a worksite, wherein the worksite model comprises a simulated operation of a machine associated with the worksite;
generating, via the one or more computing devices, visualization information, based on at least a portion of the first data;
receiving, via the one or more computing devices, perspective information relating to a view of the worksite; and
causing a visualization to be rendered based at least on the visualization information and the perspective information.

16. The computer readable storage medium of claim 15, wherein the visualization may be controlled using one or more of fast-forward, pause, and rewind.

17. The computer readable storage medium of claim 15, wherein the visualization is rendered as a visual overlay on a real-life, direct view of the worksite rendered via at least a semi-transparent material disposed between the user's eye and the actual worksite.

18. The computer readable storage medium of claim 15, wherein the perspective information comprises a location and orientation of the user.

19. The computer readable storage medium of claim 15, wherein the visualization information comprises first positional data and the perspective information comprises second positional data, and wherein causing the visualization to be rendered is further based on a correlation between first positional data and second positional data.

20. The computer readable storage medium of claim 15, wherein the visualization comprises an animation of the machine associated with the worksite.
